(19) United States
(12) Patent Application Publication
(10) Pub. No.: US 2026/0330708 A1
(43) Pub. Date: Oct. 22, 2026

(54) A COMPUTER SOFTWARE MODULE ARRANGEMENT, A CIRCUITRY ARRANGEMENT, AN ARRANGEMENT AND A METHOD FOR IMPROVED HUMAN PERCEPTION IN XR SYSTEMS

(71) Applicant: Telefonaktiebolaget LM Ericsson (publ), Stockholm (SE)

(72) Inventors: Tobias WIDMARK, Lund (SE); Andreas KRISTENSSON, Södra Sandby (SE)

(21) Appl. No.: 19/112,398

(22) PCT Filed: Oct. 10, 2022
(86) PCT No.: PCT/EP2022/078090

§ 371 Date: Mar. 17, 2025

(51) Int. Cl. G06T 11/10; G06F 3/01; G06V 20/20; G06V 40/18

(52) U.S. Cl. CPC G06T 11/10; G06F 3/013; G06V 20/20; G06V 40/18

(57) ABSTRACT

An AR viewing arrangement to detect a user's gaze and to adapt the objects displayed based on whether they are in the main field of view or the peripheral field of view.

### TECHNICAL FIELD

The present invention relates to an arrangement, an arrangement comprising computer software modules, an arrangement comprising circuits, and a method for providing an improved manner of assisting human perception, or rather human vision, in extended reality systems.

### BACKGROUND

One of the key questions regarding Augmented Reality (AR) technology is how to provide extra information to users without overloading or overwriting other senses. When it comes to visual information specifically, it becomes a trade-off between the amount of information to provide versus what the user is able to focus on. Furthermore, most AR devices available provide a static viewport bounded by the display; information is often locked to a specific location either on the display or in the virtual world representation, with little regard for where the user is directly looking.

There is thus a need for an improved manner of providing visual information to a user in a manner that the user is able to perceive the information, which manner of providing information visually facilitates the user's vision so as to improve a continued and guided human-machine interaction process

### SUMMARY

The human field of vision is divided into at least two main fields of vision, namely the main field of vision and the peripheral field of vision, also referred to as peripheral vision. The inventors have realized that as human vision is not the same in the main field of vision as in the peripheral field of vision, a user will not solely have difficulties perceiving and processing any visual information provided therein but may actually have difficulties seeing the visual information. The inventors are therefore proposing a solution that is not static in its display of information but adapts the information to be displayed based on the location relative the user's gaze thereby ensuring or at least increasing the chances that the visual information is actually seen by the user.

An object of the present teachings is therefore to overcome or at least reduce or mitigate the problems of the prior art, by providing a manner of tracking the gaze of a user and to display objects in the main field of view as the natural objects or through a basic virtual object and to display objects of interest in the peripheral field of view as a virtual object with an adapted representation.

According to one aspect an AR viewing arrangement is provided, the AR viewing arrangement comprises a circuit for receiving image data and a circuit for processing the image, wherein the circuit for receiving image data is configured to receive an image of a real-world view, and wherein the circuit for processing the image is configured to determine a main field-of-view (MFOV) and a peripheral field-of-view (PFOV) in the image data; detect an object in the image data; determine if the object is in the peripheral field-of-view (PFOV), and if so provide a graphical representation for the object in a second format, and if not provide a graphical representation for the object in a first format, wherein the first format is different from the second format.

The solution may be implemented as a software solution, a hardware solution or a mix of software and hardware components.

In some embodiments the second format is in black and white, and wherein the first format is in color.

In some embodiments the first format is the original image of the object.

In some embodiments the circuit for receiving image data is configured to receive image data corresponding to a rear-view of the AR viewing arrangement, and wherein the circuit for receiving image data is further configured to detect an eye (E) in the image data corresponding to the rear-view and to determine a gaze (G) based on the detected eye (E), and to determine the main field-of-view (MFOV) and the peripheral field-of-view (PFOV) in the image data based on the gaze (G). This allows the display to follow a gaze of a user, to adapt the displayed content accordingly so as to facilitate the human vision, increasing the chances of objects in the peripheral vision being perceived visually (ie seen).

In some embodiments the circuit for image processing is further configured to detect an event for the detected object and provide the graphical representation to indicate the event. This enables the arrangement to increase the chances of the user seeing the event, such as a change.

In some embodiments the circuit for image processing is further configured to detect an event for the detected object in the peripheral field-of-vision and provide a further graphical representation for the event.

In some embodiments the circuit for image processing is further configured to detect that the detected object has moved, and in response thereto provide the graphical representation in the other format.

In some embodiments the circuit for image processing is further configured to detect that the gaze (G) has moved and in response thereto determine updated main field of view and peripheral field of view determine if any detected object in the peripheral field of vision falls within the updated main field of vision, and in response thereto provide the graphical representation in the first format; and determine if any detected object in the main field of vision falls within the updated peripheral field of vision, and in response thereto provide the graphical representation in the second format. This enables the AR viewing arrangement to adapt to a user's gaze, thereby always maximizing the chances for an object in the peripheral to be visually perceived by the user.

In some embodiments the graphical representation for the detected object in the peripheral field-of-view comprises a color-scale ranging from full color to black and white, wherein the amount of color is based on a distance from a center (G) of the field-of-view.

In some embodiments the graphical representation for the detected object in the peripheral field-of-view comprises an intensity, wherein the amount of intensity is based on a distance from a center (G) of the field-of-view, wherein the intensity grows with the distance.

In some embodiments the graphical representation for the detected object in the peripheral field-of-view comprises a changing component.

In some embodiments the AR viewing arrangement further comprises a circuit for displaying image data configured to display the image of the real-world and to display the graphical representation of over the detected object.

In some embodiments the graphical representation for the detected object in the peripheral field-of-view comprises a graphical object arranged to cover the detected object as displayed.

In some embodiments the graphical representation for the detected object in the peripheral field-of-view comprises a graphical object arranged to frame the detected object as displayed.

In some embodiments the graphical representation for the detected object in the peripheral field-of-view comprises an identifier for the detected object, wherein the detected object is a searched-for object.

In some embodiments the AR viewing arrangement is a head-worn device.

In some embodiments the AR viewing arrangement is a head-up display device.

In some embodiments the AR viewing arrangement is a tablet computer device.

In some embodiments the AR viewing arrangement is a smartphone.

In some embodiments the AR viewing arrangement further comprises a front-facing image sensor and a rear-facing image sensor, such as a front-facing camera and a rear-facing camera.

In some embodiments the AR viewing arrangement is comprised in a camera or other image sensor device.

In some embodiments the AR viewing arrangement is a display possibly to be used with another device or in another device.

In some embodiments the AR viewing arrangement is arranged to be used in image retrieval, industrial use, robotic vision and/or video surveillance.

As opposed to existing solutions for notifying the user of events, the proposed solution manages to achieve the provision of visual information in a non-intrusive, lightweight way, leveraging the use of AR and Object Recognition/Object Detection to provide a greater degree of control over the notifications and scanning the environment for relevant objects.

The proposed solution provides a new way to be aware of one's surroundings thanks to:
Providing notifications with limited distraction in the visual field
Detecting relevant objects that the user would otherwise have difficulty noticing
Using gaze tracking to determine what notifications should be shown and prioritized

The AR viewing arrangement according to the teachings herein is thus enabled to provide indicators for certain objects and events in the peripheral vision, relying on motion and certain coloring of indicators to signify importance/type of event.

The AR viewing arrangement according to the teachings herein is thus also enabled to provide visual AR indicators that respond dynamically to real-time updates in the environment, to ensure that the user is being alerted by relevant and current events.

The AR viewing arrangement according to the teachings herein is thus also enabled to adapt its peripheral vision indicators to the user's gaze, to ensure that the indicators do not impede on the main field of vision and cause unnecessary distractions or visual impairments.

According to one aspect a method for use in an AR viewing arrangement is provided, the method comprising receiving image data and determining a main field-of-view (MFOV) and a peripheral field-of-view (PFOV) in the image data. The method further comprises detecting an object in the image data, and determining if the object is in the peripheral field-of-view (PFOV), and if so providing a graphical representation for the object in black and white, being an example of a second format. And if the object is in the main field of view providing a graphical representation for the object in a first format, wherein the first format is different from the second format. And, in some embodiments, the method further comprises detecting a change in gaze and adapting or updating the peripheral and main field of visions accordingly as well as any graphical representations if needed.

According to one aspect there is provided a computer-readable medium carrying computer instructions that when loaded into and executed by a controller of an AR viewing arrangement enables the AR viewing arrangement to implement a method according to herein.

According to one aspect there is provided a software component arrangement, wherein the software component arrangement comprises: a software component for receiving image data and a software component for determining a main field-of-view (MFOV) and a peripheral field-of-view (PFOV) in the image data. The software component arrangement further comprises a software component for detecting an object in the image data, and a software component for determining if the object is in the peripheral field-of-view (PFOV), and a software component for providing a graphical representation for the object in a second format if so. And a software component for providing a graphical representation for the object in a first format, wherein the first format is different from the second format, if the object is in the main field of view. And, in some embodiments, the software component arrangement further comprises a software component for detecting a change in gaze and adapting or updating the peripheral and main field of visions accordingly as well as any graphical representations if needed.

In some embodiments the software component arrangement further comprises software component(s) for performing any of the functionalities discussed herein.

According to one aspect there is provided an arrangement comprising circuitry, wherein the arrangement comprising circuitry comprises: circuitry for receiving image data and circuitry for determining a main field-of-view (MFOV) and a peripheral field-of-view (PFOV) in the image data. The arrangement further comprises circuitry for detecting an object in the image data, and circuitry for determining if the object is in the peripheral field-of-view (PFOV), and circuitry for providing a graphical representation for the object in a second format if so. And circuitry for providing a graphical representation for the object in a first format, wherein the first format is different from the second format, if the object is in the main field of view.

In some embodiments, the arrangement further comprises circuitry for detecting a change in gaze and adapting or updating the peripheral and main field of visions accordingly as well as any graphical representations if needed.

Further embodiments and advantages of the present invention will be given in the detailed description. It should be noted that the teachings herein find use in AR viewing arrangements in many areas of computer vision, including image retrieval, industrial use, robotic vision, augmented reality and video surveillance.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of an AR viewing arrangement according to an embodiment of the present invention.

FIG. 1B shows a schematic view of an AR viewing arrangement according to an embodiment of the present invention.

FIG. 1C shows a schematic view of an AR viewing arrangement according to an embodiment of the present invention.

FIGS. 2A,2B, 2C, 2D and 2E each shows a schematic view of an AR viewing arrangement according to one embodiment of the teachings herein.

FIG. 3 shows a flowchart of a general method according to an embodiment of the present invention.

FIG. 4 shows a component view for a software component arrangement according to an embodiment of the teachings herein.

FIG. 5 shows a component view for an arrangement comprising circuits according to an embodiment of the teachings herein.

FIG. 6 shows a schematic view of a computer-readable medium carrying computer instructions that when loaded into and executed by a controller of an arrangement enables the arrangement to implement an embodiment of the present invention.

### DETAILED DESCRIPTION

The teachings herein describe a notification system for an AR device that uses gaze tracking to determine the part of the device's display is in the user's peripheral vision, and then notifies the user of events through graphics that move in the user's periphery. These events are based on real world information gathered through Object Detection (and/or Object Recognition) that would otherwise be difficult to perceive in the user's peripheral vision. As some or all processing may be performed in a separate device than the actual display device, the device will hereafter be referred to as an arrangement which may comprise one or more devices or be connected to one or more devices.

Augmented Reality (AR) is a term for technology that involves combining the real world with virtual environments, enhancing, or changing a user's perception of the real world. Virtual objects are represented by using displays, speakers, haptics, or other mediums, intersecting with the actual physical real-world environment. An example would be a pair of glasses that has an integrated heads-up display that can show for example a virtual model of a building in the place of where another building is already standing.

Object Detection (OD) and the closely associated technology Object Recognition (OR) are used to digitally perceive and identify objects from a dataset or data stream. This is often done using cameras, where the OD software is able to register where objects are located while the OR software identifies what the objects being detected are. An example would be a recording of a bedroom, where the OD/OR software correctly identifies and locates a bed, a drawer, and a window in the recording. In the following, no difference will be made between OD and OR and also for other image analysis such as image classification.

Peripheral vision (PV) is the part of human vision that occurs outside a person's point of fixation, i.e., what a person is capable of seeing that they are not looking directly at outside the main field of vision. While the exact definition differs depending on usage, it is commonly referred to as the vision available 30 degrees outside an eye's focus point, the main field of vision being the 30 degrees from the eye's focus point, bounded by the edges of said eye's vision (100-110 degrees on each side horizontally, 65 degrees vertically). As the inventors have realized, a defining feature of peripheral vision is that visual acuity and color perception is greatly reduced when moving out from the center. While color perception is reduced, peripheral vision is capable of motion detection and in low-light conditions it excels over central vision at detecting light.

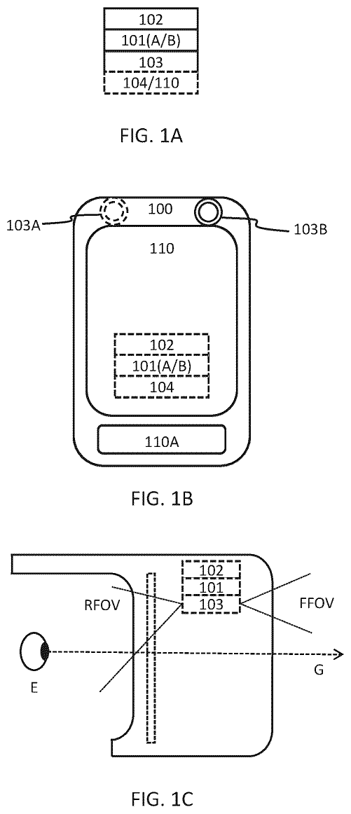

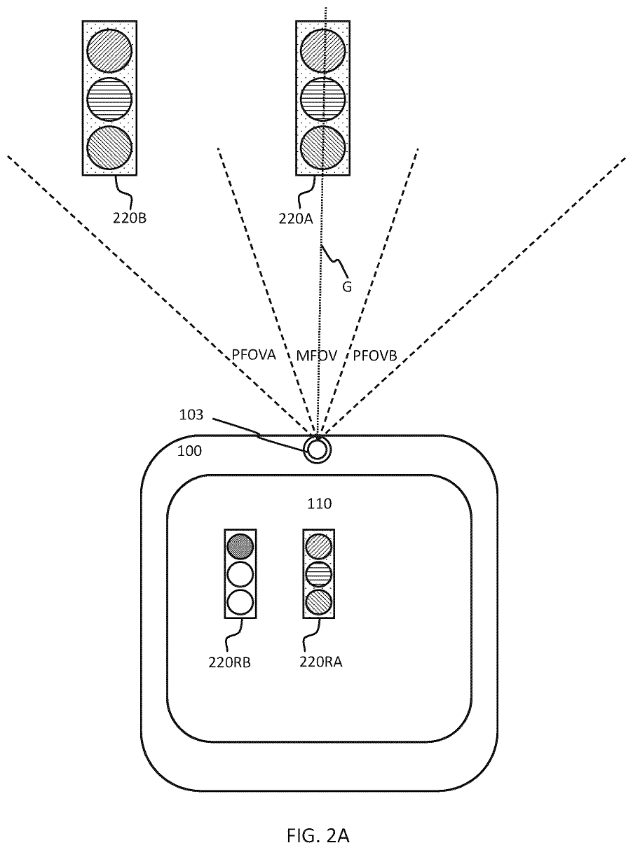

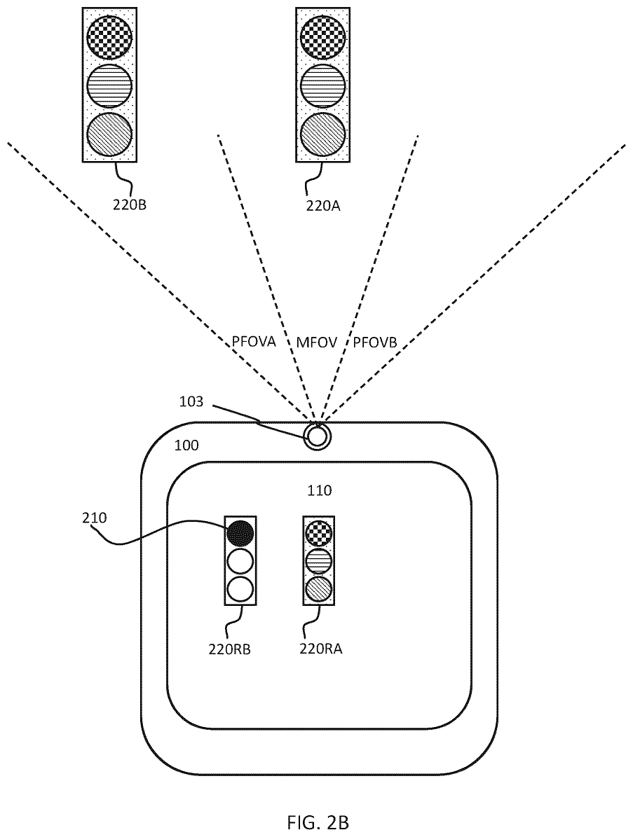

FIG. 1A shows a schematic view of an AR viewing arrangement 100 according to an embodiment of the present invention. The AR viewing arrangement comprises a controller 101, a memory 102, an image data receiving device 103, such as for example a camera or image sensor, an image streaming device (such as a communication interface) or an image data reading device arranged to read image data from the memory 102. The controller 101 is configured to receive at least one image data file, corresponding to at least an image, from the image data receiving device 103, and to perform object detection (to be understood as being an alternative to or including any of image recognition or image classification or segmentation) on the image data. The image data receiving device 103 may be comprised in the AR viewing arrangement 100 by being housed in a same housing as the AR viewing arrangement, or by being connected to it, by a wired connection or wirelessly.

It should be noted that the AR viewing arrangement 100 may comprise a single device or may be distributed across several devices and apparatuses.

The controller 101 is also configured to control the overall operation of the AR viewing arrangement 100. In some embodiments, the controller 101 is a graphics controller. In some embodiments, the controller 101 is a general-purpose controller. In some embodiments, the controller 101 is a combination of a graphics controller and a general-purpose controller. In some embodiments, the controller comprises several circuits for performing various tasks, processing or sub-processing as discussed herein. In some embodiments, the controller comprises circuit 101A for receiving image data and a circuit 101B for processing the image. As a skilled person would understand there are many alternatives for how to implement a controller, such as using Field-Programmable Gate Arrays circuits, AISIC, GPU, etc. in addition or as an alternative. For the purpose of this application, all such possibilities and alternatives will be referred to simply as the controller 101.

The memory 102 is configured to store graphics data and computer-readable instructions that when loaded into the controller 101 indicates how the AR viewing arrangement 100 is to be controlled. The memory 102 may comprise several memory units or devices, but they will be perceived as being part of the same overall memory 102. There may be one memory unit for a display arrangement storing graphics data, one memory unit for image capturing device storing settings, one memory for the communications interface (see below) for storing settings, and so on. As a skilled person would understand there are many possibilities of how to select where data should be stored and a general memory 102 for the AR viewing arrangement 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

It should be noted that the teachings herein find use in AR viewing arrangements in many areas of computer vision, including object detection in mixed or augmented reality systems, image retrieval, industrial use, robotic vision and video surveillance where a basic AR viewing arrangement 100 such as in FIG. 1A may be utilized. In some embodiments, the AR viewing arrangement 100 is a digital camera or other image sensor device (or comprised in such device). In some embodiments, the AR viewing arrangement 100 is connected to a digital camera or other image sensor device.

FIG. 1B shows a schematic view of an AR viewing arrangement being a viewing device 100 according to an embodiment of the present invention. In this embodiment, the viewing device 100 is a smartphone or a tablet computer. In such an embodiment, the viewing device further comprises a display arrangement 110, which may be a touch display, and the image data receiving device 103 may be a series of cameras of the smartphone or tablet computer. In such an embodiment the controller 101 is configured to receive an image from the camera (or other image receiving device) 103, detect objects in the image and display the image on the display arrangement 110 along with virtual content indicating or being associated with the detected object(s). The display 110 is seen to comprise a display circuit configured to display graphics as received from and possibly processed by the controller 101.

In the example embodiment of FIG. 1B, one camera 103A is arranged on a backside (opposite side of the display 110, as is indicated by the dotted contour of the camera 103A) of the AR viewing arrangement 100 for enabling real life objects behind the AR viewing arrangement 100 to be captured and shown to a user (not shown in FIG. 1B) on the display 110 along with any displayed virtual content. And one camera 103B is arranged on a frontside (same side as the display 110) of the AR viewing arrangement 100 for tracking the user's gaze.

The displayed virtual content may be information and/or graphics indicating and/or giving information on detected objects. An AR viewing device such as in FIG. 1B may be worn in a headset whereby it becomes a see-through device as discussed in relation to FIG. 1C below.

FIG. 1C shows a schematic view of an AR viewing arrangement being or being part of an optical see-through (OST) viewing device 100 according to an embodiment of the present invention. The viewing device 100 is a see-through device, where a user looks in through one end, and sees the real-life objects in the line of sight at the other end of the viewing device 100. The viewing device 100 is in some embodiments a virtual reality device.

In some embodiments the viewing device 100 is a head-mounted viewing device 100 to be worn by a user (not shown explicitly in FIG. 1C) for looking through the viewing device 100. In one such embodiment the viewing device 100 is arranged as glasses, or other eye wear including goggles, to be worn by a user.

The viewing device 100 is in some embodiments arranged to be hand-held, whereby a user can hold up the viewing device 100 to look through it.

The viewing device 100 is in some embodiments arranged to be mounted on for example a tripod, whereby a user can mount the viewing device 100 in a convenient arrangement for looking through it. In one such embodiment, the viewing device 100 may be mounted on a dashboard of a car or other vehicle.

The viewing device comprises a display arrangement 110 for presenting virtual content to a viewer and an image data receiving device 103 for receiving image data. As disclosed above with reference to FIG. 1A, the image data receiving device 103 may be remote and comprised in the AR viewing arrangement through a connection to the AR viewing arrangement 100. In the example of FIG. 1C, the image data receiving device is one or more cameras 103 of which at least one is arranged to perceive a forward field of view for capturing image data of the real world looked at by the user, and at least one for capturing aa rear field of view for capturing an image of the user's eye E to enable gaze tracking of the user's gaze G.

In the following, simultaneous reference will be made to the AR viewing arrangements 100 of FIGS. 1A, 1B and 1C.

In some embodiments the AR viewing arrangement 100 may further comprise a communication interface (not shown explicitly but taken to be part of the controller 101). The communication interface may be wired and/or wireless. The communication interface may comprise several interfaces.

In some embodiments the communication interface comprises a USB (Universal Serial Bus) interface. In some embodiments the communication interface comprises a HDMI (High Definition Multimedia Interface) interface. In some embodiments the communication interface comprises a Display Port interface. In some embodiments the communication interface comprises an Ethernet interface. In some embodiments the communication interface comprises a MIPI (Mobile Industry Processor Interface) interface. In some embodiments the communication interface comprises an analog interface, a CAN (Controller Area Network) bus interface, an 12C (Inter-Integrated Circuit) interface, or other interface.

In some embodiments the communication interface comprises a radio frequency (RF) communications interface. In one such embodiment the communication interface comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface comprises a cellular communications interface such as a fifth generation (5G) cellular communication interface, an LTE (Long Term Evolution) interface, a GSM (Global Systeme Mobile) interface and/or other interface commonly used for cellular communication. In some embodiments the communications interface is configured to communicate using the UPnP (Universal Plug n Play) protocol. In some embodiments the communications interface is configured to communicate using the DLNA (Digital Living Network Appliance) protocol.

In some embodiments, the communications interface is configured to enable communication through more than one of the example technologies given above. As an example, a wired interface, such as MIPI could be used for establishing an interface between the display arrangement, the controller and the user interface, and a wireless interface, for example WiFi™ could be used to enable communication between the AR viewing arrangement 100 and an external host device (not shown).

The communications interface may be configured to enable the AR viewing arrangement 100 to communicate with other devices, such as other AR viewing arrangements 100 and/or smartphones, Internet tablets, computer tablets or other computers, media devices, such as television sets, gaming consoles, video viewer or projectors (not shown), or image capturing devices for receiving the image data streams.

A user interface 104 may be comprised in the AR viewing arrangement 100 (only shown in FIG. 1B). Additionally or alternatively, (at least a part of) the user interface 104 may be comprised remotely in the AR viewing arrangement 100 through the communication interface, the user interface then (at least a part of it) not being a physical means in the AR viewing arrangement 100, but implemented by receiving user input through a remote device (not shown) through the communication interface. One example of such a remote device is a game controller, a mobile phone handset, a tablet computer or a computer.

As mentioned above, the teachings herein aim to provide visual notifications in a way that allows the user's central vision to remain clear while the AR device is in use as well as enabling a user to see (visually perceive as opposed to cognitively perceive) object in the peripheral vision. Since the notifications follows the user's periphery dynamically there is no risk for the user to find their vision blocked when they change direction they look in. When the user looks directly at the object they are being notified of, the notification can seamlessly disappear from the device display. As human color perception deteriorates the further out along the periphery one goes, using motion such as blinking or slight movement can be a good visual indicator. As the eye is also more sensitive to light and light changes, using a starker contrast in the peripheral vision is also a good visual indicator. In some embodiments, the starker contrast is achieved through using black and white, which ensures that a desired contrast is visually perceived by a user regardless o that user's ability to perceive colors in the peripheral field of vision.

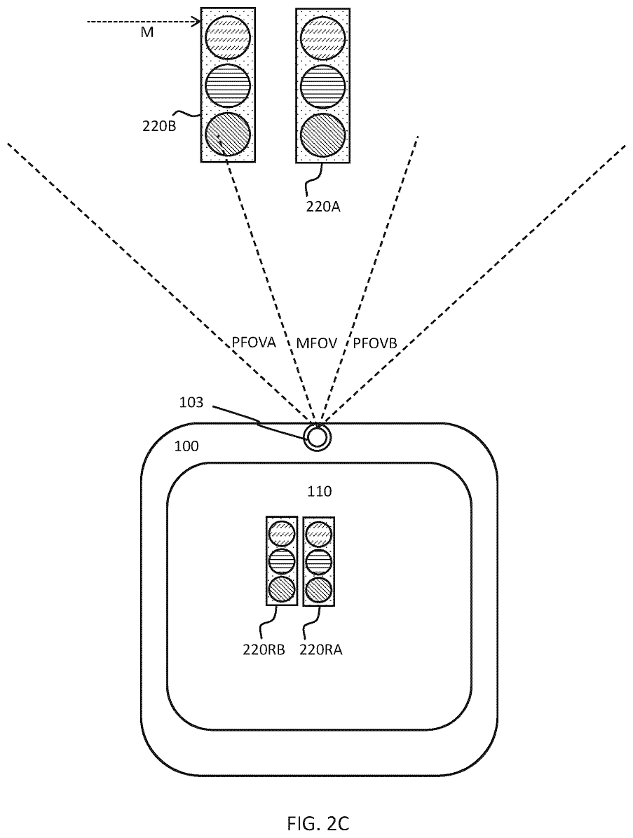

FIG. 2A is a schematic view of an AR viewing arrangement as in any of FIG. 1A, 1B or 1C. In the example of FIG. 2A a user is looking at a scene where there are two objects 220A, 220B that are detected by the controller of the AR viewing arrangement 100. Of course there may be more objects and all objects may also not be detected by the AR viewing arrangement 100, but only two objects are shown for illustrative reasons. In the example of FIG. 2A, the objects 220 are traffic lights, but may be any type of object as would be understood.

As shown, one object 220A is in the main field of view MFOV (centered along a center of gaze, reference G), whereas the other object 220B is in a peripheral field of view PFOVA. As would be understood, the peripheral vision surrounds the main field of vision and will thus be illustrated as two peripheral field of visions, one on each side of the main field of view.

However, it should be noted that an implementation may not have such a partition into a first and a second field of view, but they may be regarded as one field of view and no difference will be made between any such peripheral field of views in the description herein, unless specifically indicated. The AR viewing arrangement 100 is thus configured to determine the main field of view and the peripheral filed of view based on the center of the gaze. In some embodiments, the gaze G is detected through the rear field of vision as received or captured by the image receiving device 103 or as received by the image receiving circuit. The gaze may be detected in may different and alternative manners as would be understood by a skilled person, based on image analysis of a rear field (towards the user) of view image capture. The AR viewing arrangement 100 is thus, in some embodiments, further configured to receive image data corresponding to a rear-view of the AR viewing arrangement 100 (through the circuit for receiving image data 101A), and detect an eye E in the image data corresponding to the rear-view and to determine a gaze G based on the detected eye E, and to determine the main field-of-view MFOV and the peripheral field-of-view PFOV in the image data based on the gaze G (through the circuit for receiving image data 101B).

Upon startup the gaze may be a default gaze as in the center of the AR viewing arrangement 100. In some embodiments the peripheral field of view is determined as the view outside the main field of view, and is in some embodiments the field of view outside a view angle (20, 25, 30 or 35 degrees) from the center of gaze G. In some embodiments, the view angle is set by a user through user selection. In some embodiments, the view angle is set by the controller through noting successful visual perception by a user. Visual perception can be determined to be successful if a corresponding action is taken or not, wherein if an action is taken for a same event in one viewing angle, but not in another, the peripheral field of vision can be adapted to ensure successful interaction.

As is also shown in FIG. 2A, the first object 220A, the object in the main field of view, is detected, determined to be in the main field of vision and then displayed as is on the display 110 of the AR viewing arrangement 100. This is illustrated in FIG. 2A by the visual representation 220RA on the display 110 having the same coloring scheme as the real-life object 220A. That the object is displayed “as is” (which is to be understood as without any visual manipulation such as being overlaid with a virtual representation) is one example of a basic or first format. Other examples include being overlaid with a graphical representation, such as a virtual object, which has not been modified. More examples will be discussed below.

A second object 220B is also shown in FIG. 2A, the object in the peripheral field of view PFOVA, which is also detected, determined to be in the peripheral field of vision and then displayed in an amended or adapted format on the display 110 of the AR viewing arrangement 100. This is illustrated in FIG. 2A by the visual representation 220RB on the display 110 not having the same coloring scheme as the second real-life object 220B. That the object is displayed in an adapted or second format, which is to be understood as being displayed with visual manipulation such as being overlaid with a virtual representation, is one example of an adapted or second format. Other examples include being overlaid with a graphical representation, such as a virtual object, where colors are exchanged for a grey scale, where colors are exchanged for black or white, where the virtual representation includes a changing (such as blinking or changing color including grey scale) component, and/or where the virtual representation includes a moving (such as shaking) component. More examples will be discussed below. In some embodiments the first format is simply to display the object (or its virtual object) in colors and the second format is to display the virtual object in black and white. In some embodiments the first format is simply to display the object (or its virtual object) as the original image of the object.

8. The AR viewing arrangement according to any preceding claim, wherein the graphical representation 220RB for the detected object 220B in the peripheral field-of-view comprises a color-scale ranging from full color to black and white, wherein the amount of color is based on a distance from a center (G) of the field-of-view. [THIS NEEDS FURTHER DETAILS]

In some embodiments the graphical representation 220RB for the detected object 220B in the peripheral field-of-view comprises an intensity, wherein the amount of intensity is based on a distance from a center (G) of the field-of-view, wherein the intensity grows with the distance. The second format may thus include an intensity which in some embodiments is a brightness level, in some embodiments a contrast level, in some embodiments a special color scale where a more striking color is used further from the center (for example the further away from the center the more black will the representation be), in some embodiments a size, in some embodiments a boldness, in some embodiments a speed of blinking, in some embodiments aa speed of moving or any combination of these examples.

In some embodiments the graphical representation 220RB for the detected object 220B in the peripheral field-of-view comprises a changing component. The second format may thus include a moving or blinking component as discussed in the above.

In some embodiments the AR viewing arrangement 100 is configured to display the image of the real-world and to display the graphical representation of 220RB over the detected object 220B. The second format may thus include a virtual object over or around the detected object to highlight the detected object. In some such embodiments the graphical representation 220R for the detected object 220B in the peripheral field-of-view comprises a graphical object arranged to cover the detected object 220 as displayed (i.e. to cover the image of the object). The second format may thus include a virtual object that covers the object to alter its appearance.

In some embodiments the graphical representation 220RB for the detected object 220B in the peripheral field-of-view comprises a graphical object arranged to frame the detected object 220 as displayed. The second format may thus include a framing component.

It should be noted that any display of an object on a display 110 is providing a graphical representation and does not necessarily mean that a virtual object or other object is provided.

In some embodiments the AR viewing arrangement 100 is configured to receive a search query from a user, and in response thereto determine if any, some or all of the detected objects correspond to the search query and if so, provide an identifier for that object. In some embodiments, the AR viewing arrangement 100 is configured to do this for all detected objects matching the search query, but in some embodiments the AR viewing arrangement 100 is configured to do this only for the detected objects matching the search query in the peripheral field of view. This may be for all search queries or specific to one search query.

The identifier may be provided as a further graphical representation 210. The identifier may be provided as indicating the search query, for example through text.

The AR viewing arrangement 100 is thus, in some embodiments, further configured to provide the graphical representation 220RB for the detected object 220B in the peripheral field-of-view comprising an identifier for the detected object, wherein the detected object is a searched-for object.

The AR viewing arrangement 100 is thus configured to receive an image of a real-world view (through the circuit for receiving image data 101A), and determine a main field-of-view (MFOV) and a peripheral field-of-view (PFOV) in the image data; detect an object 220A, 220B in the image data; determine if the object 220A, 220B is in the peripheral field-of-view (PFOV), and if so provide a graphical representation 220RB for the object 220B in a second format, and if not provide a graphical representation 220RA for the object 220A in a first format (through the circuit for processing the image 101B), wherein the first format is different from the second format.

FIG. 2B shows a schematic view of an AR viewing arrangement 100 as in any of FIGS. 1A, 1B, 1C and/or 2A wherein a change is detected in any, some or all real-life objects 220. The change may be any type of change, and in some embodiments, the AR viewing arrangement 100 is further configured to classify the change as an event for the object 220. In some embodiments, the AR viewing arrangement 100 is configured to provide a notification of the event (or change). In the example of FIG. 2B the event or change is that the traffic light changes to indicate STOP—i.e. red light. The AR viewing arrangement 100 is then, in some embodiments configured to provide the graphical representation 220R to indicate the change or event.

The event for the first object 220A in the main field of view is indicated in the first format, which may be to show the object “as is” or by providing a graphical representation 220RA that highlights the event. The graphical representation 220RA that highlights the event for the first object 220A is provided in the first format. In some embodiments, the graphical representation 220RA that highlights the event will be provided in an alternative first format as compared to before the event.

The event for the second object 220B in the peripheral field of view is indicated in the second format, which may be to provide an altered graphical representation 220RB that highlights the event or to provide a further graphical representation 210 that highlights the event. The graphical representation 220RB or the further graphical representation 210 that highlights the event for the second object 220B is provided in the second format. In some embodiments, the graphical representation 220RB that highlights the event will be provided in an alternative second format as compared to before the event.

In the example of FIG. 2B, the graphical representation 220RB of the second object 220B is provided with the red light lamp indicated in a starker contrast, or alternatively or additionally, by a further graphical representation 210 which is also in a starker contrast. In some embodiments an overlaid further representation 210 is provided in order to increase the chances of visual perception, especially for embodiments where the second format includes a blinking or otherwise changing component, wherein the underlying graphical representation 212RB will still be intermittently visible. As is illustrated in FIG. 2B, the (overlaid) further graphical representation is, in some embodiments, only partially overlaying the graphical representation 220RB. In some embodiments the further graphical representation 210 overlays the graphical representation completely or almost completely.

The AR viewing arrangement 100 is thus, in some embodiments, further configured to detect an event for the detected object 220A, 220B and provide the graphical representation 220RA, 2220RB to indicate the event (through the circuit for image processing 101B). And, in some embodiments further configured to detect an event for the detected object 220B in the peripheral field-of-vision and provide a further graphical representation 210 for the event (through the circuit for image processing 101B).

It should be noted that a further graphical representation may also or alternatively be provided for the object in the main field of view to indicate the event.

FIG. 2C shows a schematic view of an AR viewing arrangement 100 as in any of FIGS. 1A, 1B, 1C, 2A and/or 2B wherein a movement M is detected in any, some or all real-life objects 220 which results in the object moving from the peripheral field of view to the main field of view (or vice-versa). As a result, the AR viewing arrangement 100 is configured to provide the object for which the movement is detected accordingly. In the example of FIG. 2C, the second object 220B moves from the peripheral field of view to the main field of view and the graphical representation 220RB is provided in the first format for the second object 220B, as opposed to in the second format as before the movement. In cases where the movement is from the main field of view to the peripheral field of view, the graphical representation will be provided in the second format instead of the first format.

FIGS. 2D and 2E each shows a schematic view of an AR viewing arrangement 100 as in any of FIGS. 1A, 1B, 1C, 2A, 2B and/or 2C wherein a movement of the eye, and therefore a change in the gaze G is detected. In FIG. 2D, the user is looking straight ahead, whereas in FIG. 2E the user has moved to the right and the gaze is now steered to the left.

The AR viewing arrangement 100 is configured to detect such a change in gaze and adapt or update the field of views accordingly. The AR viewing arrangement 100 is thus configured to follow a user's gaze and to update the display accordingly. In the example of FIGS. 2D and 2E the gaze has changed so that the first object 220A previously in the main field of view MFOV ends up in the peripheral field of view PFOVB and the second object 220B previously in the peripheral field of view PFOVA ends up in the main field of view MFOV. The AR viewing arrangement 100 Is configured to update the graphical representations accordingly, whereby the graphical representation 220RA for the first object 220A is updated to the second format and the graphical representation 220RB for the second object 220B is updated to the first format.

The AR viewing arrangement 100 is thus, in some embodiments, configured to detect that the gaze G has moved and in response thereto determine updated main field of view and peripheral field of view; determine if any detected object 220B in the peripheral field of vision falls within the updated main field of vision, and in response thereto provide the graphical representation 220RB in the first format; and determine if any detected object 220A in the main field of vision falls within the updated peripheral field of vision, and in response thereto provide the graphical representation 220RB in the second format.

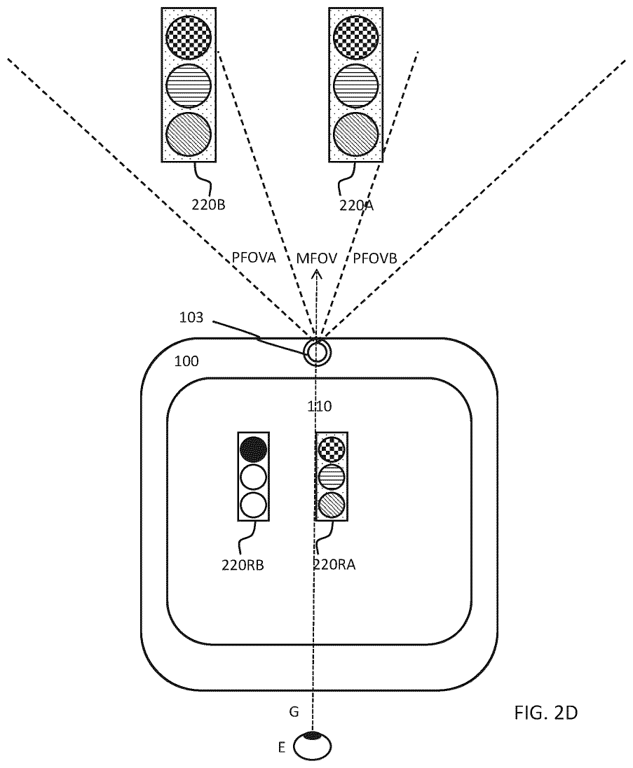

FIG. 3 shows a flowchart of a general method according to an embodiment of the teachings herein. The method utilizes an AR viewing arrangement 100 as taught herein. The method comprises receiving 310 image data and determining 320 a main field-of-view (MFOV) and a peripheral field-of-view (PFOV) in the image data. The method further comprises detecting 330 an object 220A, 220B in the image data, and determining 340 if the object 220A, 220B is in the peripheral field-of-view (PFOV), and if so providing 350 a graphical representation 220RB for the object 220B in black and white, being an example of a second format. And if the object 220A, 220B is in the main field of view providing a graphical representation 220RA for the object 220A in a first format, wherein the first format is different from the second format. As discussed in the above, the peripheral and main field of visions are determined based on a detected gaze, and, in some embodiments, the method further comprises detecting 360 a change in gaze and adapting or updating the peripheral and main field of visions accordingly as well as any graphical representations if needed.

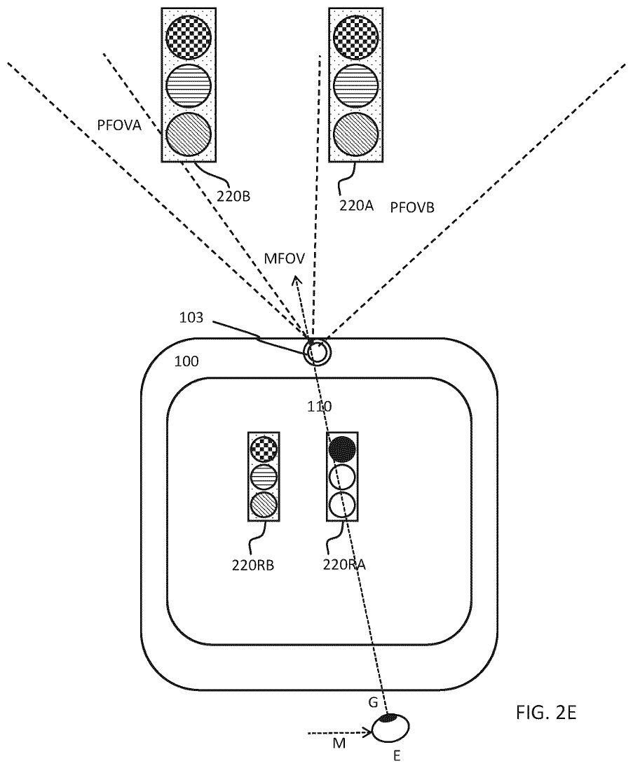

FIG. 4 shows a schematic view of a computer-readable medium 120 carrying computer instructions 121 that when loaded into and executed by a controller of an AR viewing arrangement 100 enables the AR viewing arrangement 100 to implement the present invention. The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 4, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the AR viewing arrangement 100 for being executed by the controller 101.

The computer disc reader 122 may also or alternatively be connected to (or possibly inserted into) an AR viewing arrangement 100 for transferring the computer-readable computer instructions 121 to a controller of the AR viewing arrangement (presumably via a memory of the AR viewing arrangement 100).

FIG. 4 shows both the situation when an AR viewing arrangement 100 receives the computer-readable computer instructions 121 via a wireless server connection (non-tangible) and the situation when another AR viewing arrangement 100 receives the computer-readable computer instructions 121 through a wired interface (tangible). This enables for computer-readable computer instructions 121 being downloaded into an AR viewing arrangement 100 thereby enabling the AR viewing arrangement 100 to operate according to and implement the invention as disclosed herein.

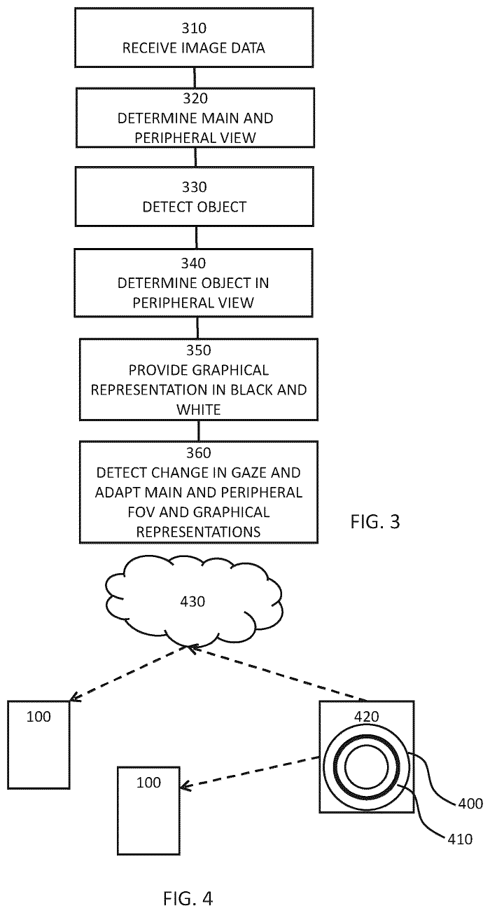

FIG. 5 shows a component view for a software component (or module) arrangement 500 according to an embodiment of the teachings herein. The software component arrangement 500 is adapted to be used in an AR viewing arrangement 100 as taught herein.

The software component arrangement 500 comprises a software component for receiving 510 image data and a software component for determining 520 a main field-of-view (MFOV) and a peripheral field-of-view (PFOV) in the image data. The software component arrangement 500 further comprises a software component for detecting 530 an object 220A, 220B in the image data, and a software component for determining 540 if the object 220A, 220B is in the peripheral field-of-view (PFOV), and a software component for providing 550 a graphical representation 220RB for the object 220B in black and white (being an example of a second format) if so. And a software component for providing a graphical representation 220RA for the object 220A in a first format, wherein the first format is different from the second format, if the object 220A, 220B is in the main field of view. As discussed in the above, the peripheral and main field of visions are determined based on a detected gaze, and, in some embodiments, the software component arrangement 500 further comprises a software component for detecting 560 a change in gaze and adapting or updating the peripheral and main field of visions accordingly as well as any graphical representations if needed.

In some embodiments the software component arrangement 500 further comprises software component(s) for performing any of the functionalities discussed herein.

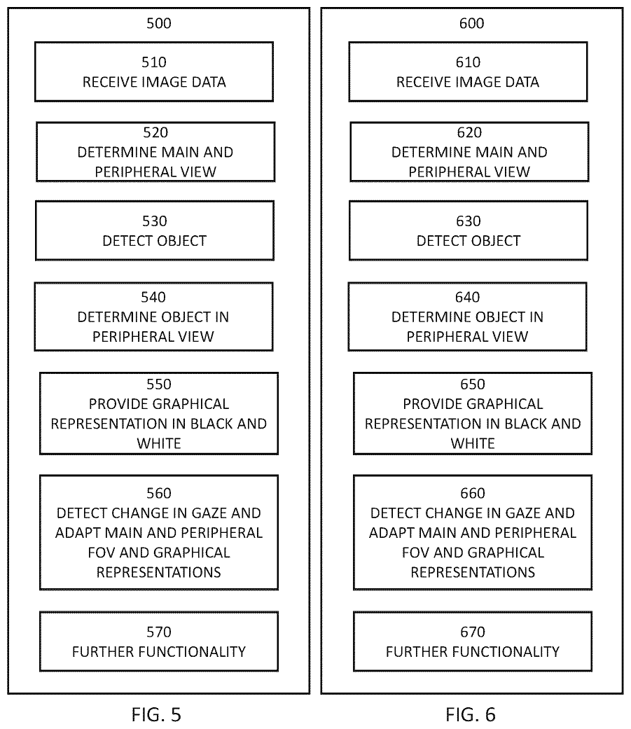

FIG. 6 shows a component view for an arrangement comprising circuitry 600 according to an embodiment of the teachings herein. The arrangement comprising circuitry 600 is adapted to be used in an AR viewing arrangement 100 as taught herein.

The arrangement comprising circuitry 600 of FIG. 6 comprises circuitry for receiving 610 image data and circuitry for determining 620 a main field-of-view (MFOV) and a peripheral field-of-view (PFOV) in the image data. The arrangement 600 further comprises circuitry for detecting 630 an object 220A, 220B in the image data, and circuitry for determining 640 if the object 220A, 220B is in the peripheral field-of-view (PFOV), and circuitry for providing 650 a graphical representation 220RB for the object 220B in black and white (being an example of a second format) if so. And circuitry for providing a graphical representation 220RA for the object 220A in a first format, wherein the first format is different from the second format, if the object 220A, 220B is in the main field of view. As discussed in the above, the peripheral and main field of visions are determined based on a detected gaze, and, in some embodiments, the arrangement 600 further comprises circuitry for detecting 660 a change in gaze and adapting or updating the peripheral and main field of visions accordingly as well as any graphical representations if needed.

In some embodiments the arrangement 600 further comprises circuitry(ies) for performing any of the functionalities discussed herein.

1. An Augmented Reality (AR) viewing arrangement comprising:
a circuit for receiving image data; and
a circuit for processing the image,
wherein the circuit for receiving image data is configured to receive an image of a real-world view; and
wherein the circuit for processing the image is configured to:
determine a main field-of-view and a peripheral field-of-view in the image data;
detect an object in the image data; and
determine if the object is in the peripheral field-of-view, and if so provide a graphical representation for the object in a second format, and if not provide a graphical representation for the object in a first format, wherein the first format is different from the second format.

2. The AR viewing arrangement according to claim 1, wherein the second format is in black and white, and wherein the first format is in color.

3. The AR viewing arrangement according to claim 1, wherein the first format is an original image of the object.

4. The AR viewing arrangement according to claim 1,
wherein the circuit for receiving image data is configured to receive image data corresponding to a rear-view of the AR viewing arrangement, and
wherein the circuit for receiving image data is further configured to:
detect an eye in the image data corresponding to the rear-view and to determine a gaze based on the detected eye, and to:
determine the main field-of-view and the peripheral field-of-view in the image data based on the gaze.

5. The AR viewing arrangement according to claim 1, wherein the circuit for image processing is further configured to;
detect an event for the detected object; and
provide the graphical representation to indicate the event.

6. The AR viewing arrangement according to claim 1, wherein the circuit for image processing is further configured to:
detect an event for the detected object in the peripheral field-of-vision; and
provide a further graphical representation for the event.

7. The AR viewing arrangement according to claim 1, wherein the circuit for image processing is further configured to detect that the detected object has moved, and in response thereto provide the graphical representation in the other format.

8. The AR viewing arrangement according to claim 1, wherein the circuit for image processing is further configured to detect that the gaze has moved and in response thereto:
determine updated main field of view and peripheral field of view;
determine if any detected object in the peripheral field of vision falls within the updated main field of vision, and in response thereto provide the graphical representation in the first format; and
determine if any detected object in the main field of vision falls within the updated peripheral field of vision, and in response thereto provide the graphical representation in the second format.

9. The AR viewing arrangement according to claim 1, wherein the graphical representation for the detected object in the peripheral field-of-view comprises a color-scale ranging from full color to black and white, wherein the amount of color is based on a distance from a center of the field-of-view.

10. The AR viewing arrangement according to claim 1, wherein the graphical representation for the detected object in the peripheral field-of-view comprises an intensity, wherein the amount of intensity is based on a distance from a center of the field-of-view, wherein the intensity grows with the distance.

11. The AR viewing arrangement according to claim 1, wherein the graphical representation for the detected object in the peripheral field-of-view comprises a changing component.

12. The AR viewing arrangement according to claim 1, wherein the AR viewing arrangement further comprises a circuit for displaying image data configured to:
display the image of the real-world; and to
display the graphical representation of over the detected object.

13. The AR viewing arrangement according to claim 12, wherein the graphical representation for the detected object in the peripheral field-of-view comprises a graphical object arranged to cover the detected object as displayed.

14. The AR viewing arrangement according to claim 12, wherein the graphical representation for the detected object in the peripheral field-of-view comprises a graphical object arranged to frame the detected object as displayed.

15. The AR viewing arrangement according to claim 1, wherein the graphical representation for the detected object in the peripheral field-of-view comprises an identifier for the detected object, wherein the detected object is a searched-for object.

16. The AR viewing arrangement according to claim 1, wherein the AR viewing arrangement is a head-worn device.

17. The AR viewing arrangement according to claim 1, wherein the AR viewing arrangement is a head-up display device.

18. The AR viewing arrangement according to claim 1, wherein the AR viewing arrangement is a tablet computer device.

19. The AR viewing arrangement according to claim 1, wherein the AR viewing arrangement is a smartphone.

20. The AR viewing arrangement according to claim 1 further comprising a front-facing image sensor and a rear-facing image sensor.

21. A method for use in an Augmented Reality (AR) viewing arrangement comprising a circuit for receiving image data and a circuit for processing the image, wherein the method comprises:
the circuit for receiving image data receiving an image of a real-world view; and
the circuit for processing the image:
determining a main field-of-view and a peripheral field-of-view in the image data;
detecting an object in the image data; and
determining if the object is in the peripheral field-of-view, and if so providing a graphical representation for the object in a second format, and if not providing a graphical representation for the object in a first format, wherein the first format is different from the second format.

22. A nontransitory computer-readable medium carrying computer instructions that, when loaded into and executed by a controller of an Augmented Reality (AR) viewing arrangement, causes the AR viewing arrangement to implement a method according for use in an Augmented Reality (AR) viewing arrangement comprising a circuit for receiving image data and a circuit for processing the image, wherein the method comprises:
the circuit for receiving image data receiving an image of a real-world view; and
the circuit for processing the image:
determining a main field-of-view and a peripheral field-of-view in the image data;
detecting an object in the image data; and
determining if the object is in the peripheral field-of-view, and if so providing a graphical representation for the object in a second format, and if not providing a graphical representation for the object in a first format, wherein the first format is different from the second format.

23. An Augmented Reality (AR) viewing arrangement comprising:
circuit for receiving image data of a real-world view and a circuit for processing the image;
circuit for determining a main field-of-view and a peripheral field-of-view in the image data;
circuit for detecting an object in the image data; and
circuit for determining if the object is in the peripheral field-of-view, and if so providing a graphical representation for the object in a second format, and if not providing a graphical representation for the first object in a first format, wherein the first format is different from the second format.

24. (canceled)
